(19) United States
(12) Patent Application Publication
(10) Pub. No.: US 2026/0153595 A1
(43) Pub. Date: Jun. 4, 2026

(54) RADAR DEVICE

(71) Applicants: DENSO CORPORATION, Kariya-city (JP); TOYOTA JIDOSHA KABUSHIKI KAISHA, Toyota-shi (JP)

(72) Inventors: Susumu ENOKIDA, Kariya-city (JP); Eisuke IKENO, Toyota-shi (JP); Kenji FURUMOTO, Toyota-shi (JP)

(21) Appl. No.: 19/459,330

(22) Filed: Jan. 26, 2026

Related U.S. Application Data
(63) Continuation of application No. PCT/JP2024/022021, filed on Jun. 18, 2024.

(30) Foreign Application Priority Data
Jul. 28, 2023 (JP) 2023-123691

(51) Int. Cl. G01S 7/02; G01S 13/931

(52) U.S. Cl. CPC G01S 7/028; G01S 13/931

(57) ABSTRACT

A radar device used in a mobile body includes a sensor circuit board and a sensor housing. The sensor circuit board emits a radio wave so as to detect an object around the mobile body. The sensor housing defines a receiving chamber that receives the sensor circuit board. The sensor housing forms a breathing hole that reduces a pressure difference between the receiving chamber and an outside space outside the sensor housing. A drainage rib is formed on a rear-side back surface of the sensor housing so as to project from the rear-side back surface and partially surround the breathing hole. The drainage rib has a shape that opens toward a lower side of the breathing hole so as to guide drainage from the breathing hole.

### CROSS REFERENCE TO RELATED APPLICATIONS

This application is a continuation application of International Patent Application No. PCT/JP 2024/022021 filed on Jun. 18, 2024, which designated the U.S. and claims the benefit of priority from Japanese Patent Application No. 2023-123691 filed on Jul. 28, 2023. The entire disclosures of all of the above applications are incorporated herein by reference.

### TECHNICAL FIELD

The disclosure of this specification relates to a radar device used in a mobile body.

### BACKGROUND ART

A previously proposed radar device includes a case that receives electronic components such as a millimeter wave radar. This case has a breathing hole for eliminating a pressure difference between an interior of the case and outside air, and an annular projection projects from a peripheral edge of the breathing hole. The projection prevents direct application of rainwater or the like into the breathing hole.

### SUMMARY

According to the present disclosure, there is provided a radar device configured to be used in a mobile body. The radar device may include an antenna device and an antenna housing. The antenna device may be configured to emit a radio wave so as to detect an object around the mobile body. The antenna housing may define a receiving chamber, which receives the antenna device. The antenna housing may form a breathing hole that is configured to reduce a pressure difference between the receiving chamber and an outside space outside the antenna housing. A drainage rib may be formed on an outer surface of the antenna housing so as to project from the outer surface of the antenna housing and partially surround the breathing hole. The drainage rib may have a shape that opens toward a lower side of the breathing hole so as to guide drainage from the breathing hole.

### BRIEF DESCRIPTION OF DRAWINGS

The drawings described herein are for illustrative purposes only of selected embodiments and not all possible implementations, and are not intended to limit the scope of the present disclosure.

FIG. 1 is a perspective view of a radar device according to a first embodiment of the present disclosure.

FIG. 2 is a perspective view of the radar device as seen from a direction different from that of FIG. 1.

FIG. 3 is a cross-sectional view taken along line III-III in FIG. 2.

FIG. 4 is an enlarged view showing a housing recess and a drainage rib of FIG. 2.

FIG. 5 is a perspective view of a radar device according to a second embodiment of the present disclosure.

FIG. 6 is a cross-sectional view taken along line VI-VI in FIG. 5.

FIG. 7 is an enlarged view showing a housing recess and a drainage rib of FIG. 5.

FIG. 8 is a perspective view of a radar device according to a third embodiment of the present disclosure.

FIG. 9 is a cross-sectional view taken along line IX-IX in FIG. 8.

FIG. 10 is an enlarged view showing a housing recess and a drainage rib of FIG. 8.

FIG. 11 is a perspective view of a radar device according to a fourth embodiment of the present disclosure.

FIG. 12 is a cross-sectional view taken along line XII-XII in FIG. 11.

FIG. 13 is an enlarged view showing a drainage rib of FIG. 11.

FIG. 14 is a perspective view of a radar device according to a fifth embodiment of the present disclosure.

FIG. 15 is a cross-sectional view taken along line XV-XV in FIG. 14.

FIG. 16 is an enlarged view showing a drainage rib of FIG. 14.

FIG. 17 is a view showing a first modification of FIG. 16.

FIG. 18 is a view showing a second modification of FIG. 4.

FIG. 19 is a view showing a third modification of FIG. 7.

### DETAILED DESCRIPTION

A previously proposed radar device includes a case that receives electronic components such as a millimeter wave radar. This case has a breathing hole for eliminating a pressure difference between an interior of the case and outside air, and an annular projection projects from a peripheral edge of the breathing hole. The projection prevents direct application of rainwater or the like into the breathing hole.

In the case where the projection is formed in the annular shape, even when an inside of the projection is made tapered, liquid such as water tends to remain on the inside of the projection due to surface tension. Furthermore, if ventilation is hindered by the retained liquid, there is a concern that the case may deform, which could deteriorate the performance of the millimeter wave radar received in the case.

According to one aspect of the present disclosure, there is provided a radar device configured to be used in a mobile body. The radar device includes: an antenna device that is configured to emit a radio wave so as to detect an object around the mobile body; and an antenna housing that defines a receiving chamber, which receives the antenna device. The antenna housing forms a breathing hole that is configured to reduce a pressure difference between the receiving chamber and an outside space outside the antenna housing. A drainage rib is formed on an outer surface of the antenna housing so as to project from the outer surface of the antenna housing and partially surround the breathing hole. The drainage rib has a shape that opens toward a lower side of the breathing hole so as to guide drainage from the breathing hole.

According to this aspect, the drainage rib, which projects to partially surround the breathing hole, guides the drainage from the breathing hole due to the shape of the drainage rib which opens toward the lower side of the breathing hole. As a result, liquid is less likely to remain in the breathing hole. As a result, it is possible to avoid a situation where the ventilation through the breathing hole is obstructed by the liquid, thereby causing deformation of the antenna housing and deterioration of the performance of the antenna device.

Hereinafter, embodiments will be described with reference to the drawings. In each of the following embodiments, components, which correspond to each other, are indicated by the same reference signs, and redundant explanations may be omitted. Further, when only any one or more of the components are described in the respective embodiments, the description of the rest of the components described in the preceding embodiment(s) may be applied to the rest of the components. In addition to the combinations of the components that are specifically shown to be combinable in the respective embodiments, it is also possible to partially combine the embodiments even if they are not specifically shown, provided that the combinations are not impeded.

### First Embodiment

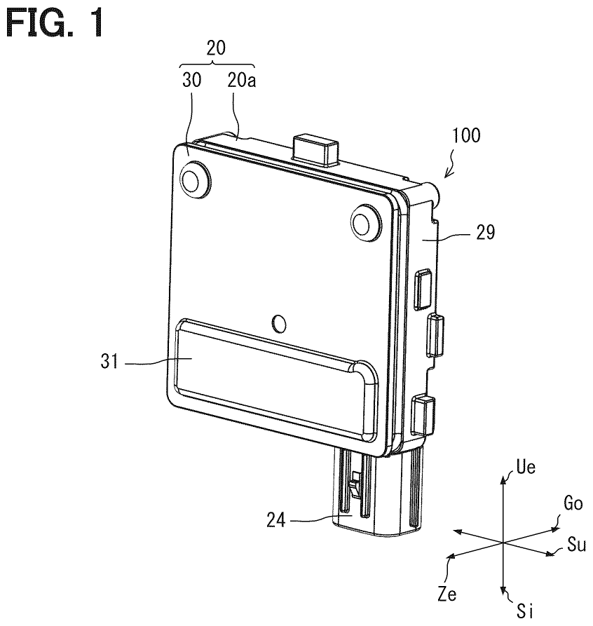

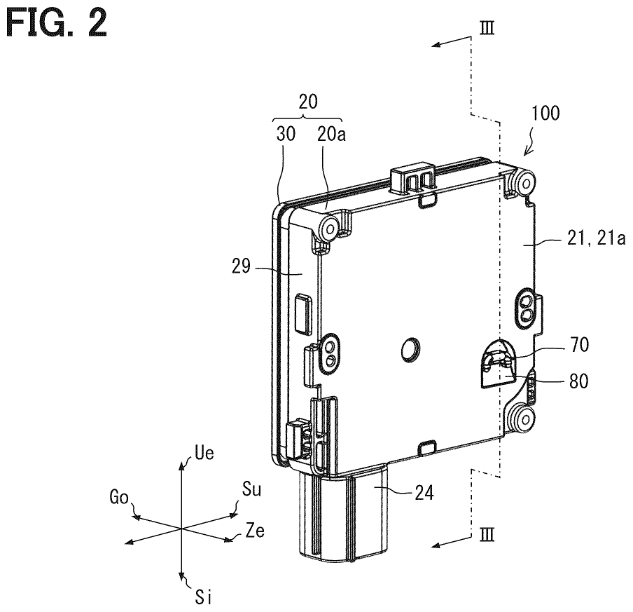

A radar device 100 according to the first embodiment of the present disclosure shown in FIGS. 1 and 2 is mounted on a mobile body such as a vehicle and is used on the mobile body. The radar device 100 is received, for example, in a space partitioned by a plate member on the vehicle side, such as a front panel or front emblem, which has a function of transmitting millimeter waves therethrough. The radar device 100 may be installed not only on the front side of the vehicle but also on various other locations, such as a lateral side and/or a rear side of the vehicle.

The radar device 100 is one of autonomous sensors used to detect the environment around the host vehicle having the radar device 100. The radar device 100 performs object detection and distance measurement using millimeter waves with, for example, a frequency of 30 to 300 GHz. In the radar device 100, for example, millimeter waves (or quasi-millimeter waves) in the 24 GHz band, 76 GHz band, and 79 GHz band are mainly used. The radar device 100 emits the millimeter waves toward the surroundings of the host vehicle. The radar device 100 detects, for example, a relative position and a relative speed of the object around the host vehicle by receiving reflected waves that are reflected by a moving object or a stationary object, such as a preceding vehicle, a pedestrian, and a cyclist, present in the vicinity of the host vehicle. The radar device 100 is capable of accurately detecting the objects around the host vehicle even under nighttime or adverse weather conditions.

Here, in the following description, each direction of the radar device 100 is defined based on an orientation of the radar device 100 in a state where the radar device 100 is mounted on the mobile body (vehicle) that is stationary on a horizontal plane. Specifically, a front-rear direction (a front side Ze and a rear side Go) is defined along a longitudinal direction (traveling direction) of the vehicle. In addition, a horizontal direction Su is defined along a width direction of the vehicle. Furthermore, an up-down direction (an upper side Ue and a lower side Si) is defined along a vertical direction (gravity direction) that is perpendicular to the horizontal plane, which defines the front-rear direction and the left-right direction.

The radar device 100 is formed in a flat rectangular parallelepiped shape as a whole. When the radar device 100 is mounted on the front side of the vehicle, the radar device 100 is installed in such a manner that a thickness direction of the radar device 100 is aligned with the front-rear direction of the vehicle. In this case, the front side Ze corresponds to the irradiation direction of the millimeter wave. The radar device 100 is mounted on the vehicle so as to have a wider field of view in the horizontal direction Su (the left-right direction) than in the up-down direction. As described above, even when the radar device 100 is in a standalone state and not mounted on the mobile body, each direction in the orientation of the radar device 100 mounted on the mobile body can be identified based on an external shape of the radar device 100 and an irradiation mode of the millimeter wave of the radar device 100.

### Structure of Radar Device

Hereinafter, details of a structure of the radar device 100 will be described with reference to FIGS. 1 to 3. The radar device 100 includes a sensor housing 20, a sensor circuit board 40 and a filter 60.

The sensor housing 20 includes a housing main body 20a and a sensor radome 30. The housing main body 20a and the sensor radome 30 are made of a resin material such as polybutylene terephthalate. The sensor housing 20 defines a receiving chamber 22 that receives the sensor circuit board 40. The receiving chamber 22 is configured as a generally liquid-tight space so as to protect the sensor circuit board 40 from rainwater, car wash water, and the like.

The housing main body 20a serves as a lower case of the sensor housing 20 and is disposed on the rear side Go of the sensor radome 30. The housing main body 20a is formed in a flat, bottomed container shape. The housing main body 20a has a housing bottom wall 21 and four housing peripheral walls 29 formed so as to surround the housing bottom wall 21.

The housing bottom wall 21 is a bottom wall of the housing main body 20a and has a generally square shape. The housing bottom wall 21 is formed to have a thickness of several millimeters (about 2 to 3 mm). An outer surface of the housing bottom wall 21, which is exposed to an outside space of the sensor housing 20 (hereinafter, referred to as a housing outside space OS), serves as a rear-side back surface 21a. An inner surface of the housing bottom wall 21, which is exposed to the receiving chamber 22, serves as an inside bottom wall surface 21b.

A single breathing hole 27 is formed in a cylindrical hole shape in the housing bottom wall 21. The breathing hole 27 is a through-hole that penetrates the housing bottom wall 21 in a wall thickness direction of the housing bottom wall 21. Of two ends of the breathing hole 27, an outer opening 27a, which faces the housing outside space OS, opens into a recess bottom wall 81, which will be described later. In contrast, of the two ends of the breathing hole 27, an inner opening 27b, which is exposed to the receiving chamber 22, opens into the inside bottom wall surface 21b. An inner diameter of an inner peripheral wall surface 27c, which connects between the outer opening 27a and the inner opening 27b (in other words, a diameter of the breathing hole 27) is set to be, for example, about 1 mm. The breathing hole 27 functions as a vent hole that connects the receiving chamber 22 to the housing outside space OS, thereby reducing a pressure difference between the housing outside space OS and the receiving chamber 22.

The housing peripheral walls 29 project toward the front side Ze from four outer edges, respectively, of the housing bottom wall 21. A circuit board support surface 23 and a connector port 24 are formed on one or more of the housing peripheral walls 29. The circuit board support surface 23 is a stepped surface that is formed on inner walls of the housing peripheral walls 29. The circuit board support surface 23 is formed so as to face the front side Ze, and the circuit board support surface 23 supports the sensor circuit board 40 from the rear side Go. The connector port 24 is provided on one of the housing peripheral walls 29, which is disposed on the lower side Si. The connector port 24 is integrally formed with the sensor circuit board 40 and projects from the housing peripheral wall 29 into the housing outside space OS. A connector, which electrically connects the sensor circuit board 40 to an external in-vehicle ECU or the like, is connected to the connector port 24. The connector port 24 may be formed on one of the housing peripheral walls 29, which is located on the lateral side of the receiving chamber 22 (i.e., facing the horizontal direction Su), or may be formed on the rear-side back surface 21a.

The sensor radome 30 serves as an upper case or cover of the sensor housing 20 and is disposed on the front side Ze of the housing main body 20a. The sensor radome 30 is formed in a square plate shape. The sensor radome 30 is held at a top end of the housing peripheral walls 29 and generally seals the receiving chamber 22 in a liquid-tight manner. The sensor radome 30 allows transmission of the millimeter waves between the receiving chamber 22 and the housing outside space OS. Of two opposite surfaces of the sensor radome 30, an outer surface, which faces the front side Ze, serves as an irradiation front surface 31 that is exposed to the housing outside space OS. In contrast, of the two opposed surfaces of the sensor radome 30, an inner surface, which faces the rear side Go, is opposed to a sensor antenna 50 (described later) while forming a slight gap between the inner surface of the sensor radome 30 and the sensor antenna 50.

The sensor circuit board 40 emits the radio waves (such as the millimeter waves) for detecting objects around the vehicle. The sensor circuit board 40 includes a circuit board main body 40a and the sensor antenna 50. The circuit board main body 40a is, for example, a circuit board made of glass epoxy board and is formed in a rigid plate form. A signal processing circuit, which is configured to detect the objects, is formed on the circuit board main body 40a. The circuit board main body 40a is mounted on the circuit board support surface 23, for example, with screws or the like and is thereby held by the housing main body 20a. Of two opposed surfaces of the circuit board main body 40a, a rear surface, which faces the rear side Go, is a component mounting surface 41. Numerous electronic components, such as a microcomputer, a power supply circuit and an amplification circuit, form the signal processing circuit and are mounted on the component mounting surface 41. On the other hand, of the two opposed surfaces of the circuit board main body 40a, a front surface, which faces the front side Ze, is an antenna mounting surface 42.

The sensor antenna 50 is formed by a plurality of antenna patterns mounted on the antenna mounting surface 42. The sensor antenna 50 includes: a plurality of transmission antenna patterns for transmitting the millimeter waves toward the front side Ze; and a plurality of reception antenna patterns for receiving reflected waves arriving from the front side Ze. Furthermore, the sensor antenna 50 may be provided as a separate component that is separate from the circuit board main body 40a. With the configuration described above, the sensor antenna 50, which has a thin plate-shape or a film-shape and includes the transmission and reception antenna as well as a millimeter wave module, is arranged along the antenna mounting surface 42 and is positioned on the front side Ze of the antenna mounting surface 42. The sensor antenna 50 is held by the circuit board main body 40a.

The filter 60 is made of, for example, a PTFE membrane or the like. The filter 60 is affixed to the inside bottom wall surface 21b by means of an adhesive or the like. The filter 60 covers the inner opening 27b of the breathing hole 27. The filter 60, in cooperation with the breathing hole 27, limits foreign substances such as dust and dirt from entering the receiving chamber 22, while ensuring ventilation between the inside and the outside of the sensor housing 20. In addition, the filter 60 has water-repellent properties, which suppress the ingress of liquids such as rainwater and car wash water into the receiving chamber 22.

### Details of Housing Recess and Drainage Rib

In the radar device 100 described above, when the liquid accumulates in the breathing hole 27, ventilation through the breathing hole 27 may be obstructed. In this case, when the ambient temperature of the radar device 100 changes and a pressure difference arises between the receiving chamber 22 and the housing outside space OS, deformation of the sensor housing 20 may occur. As a result, there is a concern that the sensor radome 30 may interfere with the sensor circuit board 40, leading to deterioration in antenna performance.

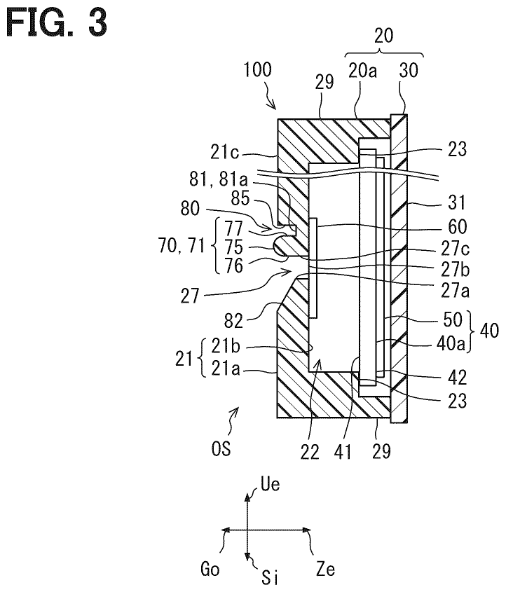

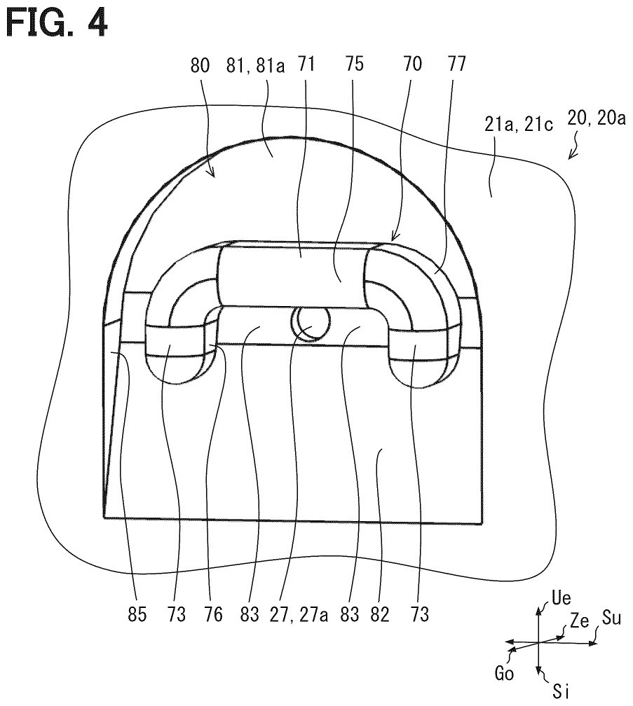

Therefore, in the sensor housing 20 of the radar device 100, a drainage structure is provided to limit the liquid from accumulating in the breathing hole 27. Specifically, the housing recess 80 and the drainage rib 70 are arranged around the breathing hole 27. Hereinafter, the details of the housing recess 80 and the drainage rib 70 will be explained with reference to FIGS. 3 and 4, while also referring to FIGS. 1 and 2.

The housing recess 80 is a portion that is recessed from the rear-side back surface 21a of the sensor housing 20 toward the receiving chamber 22 side (the front side Ze). The housing recess 80 is formed in a bell shape, which is a combination of a semicircle with its straight portion facing the lower side Si and a rectangle joined to the straight portion of the semicircle at the lower side Si, as viewed from the rear side Go. The housing recess 80, along with the breathing hole 27 and the drainage rib 70, is provided at a position where it does not interfere with the electronic components mounted on the component mounting surface 41.

The housing recess 80 has a recess peripheral wall 85 and the recess bottom wall 81. The recess peripheral wall 85 has a shape that extends along the front-rear direction and connects the reference surface portion 21c to the recess bottom wall 81. The recess peripheral wall 85 is formed at a position spaced away from the drainage rib 70. A flow passage (drainage groove), which directs the liquid toward the lower side Si, is formed between the recess peripheral wall 85 and the drainage rib 70.

The recess bottom wall 81 is a part of the rear-side back surface 21a and is positioned further toward the front side Ze than a range of the rear-side back surface 21a (hereinafter referred to as a reference surface portion 21c), which excludes the area of the rear-side back surface 21a that forms the housing recess 80. The outer opening 27a of the breathing hole 27 and the drainage rib 70 are formed on the recess bottom wall 81. The recess bottom wall 81 includes an upper surface 81a, an inclined surface 82 and a gap surface 83.

The upper surface 81a is a semicircular area of the recess bottom wall 81 which is positioned on the upper side Ue of the outer opening 27a of the breathing hole 27. The upper surface 81a is configured to be oriented along the reference surface portion 21c. The inclined surface 82 is a rectangular area of the recess bottom wall 81, which is located on the lower side Si of the outer opening 27a. The inclined surface 82 is inclined toward the rear side Go as the inclined surface 82 proceeds toward the lower side Si. According to the inclined surface 82, the depth of the housing recess 80 progressively decreases as the housing recess 80 approaches the lower side Si. In the recess bottom wall 81, the gap surface 83 is formed on each of two opposite sides of the breathing hole 27, which are opposite to each other in the horizontal direction Su. Similar to the upper surface 81a, each of the gap surfaces 83 is configured to be oriented along the reference surface portion 21c. Each gap surface 83 forms a clearance in the horizontal direction Su between the drainage rib 70 (specifically, a corresponding one of a pair of lateral portions 73 of the drainage rib 70 described later) and the breathing hole 27.

The drainage rib 70 is configured to guide the liquid, which flows into the housing recess 80 toward the breathing hole 27, in a drainage direction (lower side Si). The drainage rib 70 projects toward the rear side Go from the recess bottom wall 81, which is the part of the rear-side back surface 21a, so as to partially surround the breathing hole 27. The drainage rib 70 slightly projects from the housing recess 80 relative to the reference surface portion 21c. More specifically, in the front-rear direction, a distance between the rear-side back surface 21a and the recess bottom wall 81 is the depth of the recess bottom wall 81, and a distance between the recess bottom wall 81 and a top 75 of the drainage rib 70 is a height of the drainage rib 70. The height of the drainage rib 70 is made larger than the depth of the recess bottom wall 81. As a result, the top 75 of the drainage rib 70 is positioned on the rear side Go of the reference surface portion 21c. The height of the drainage rib 70 is made larger than the inner diameter of the breathing hole 27.

The drainage rib 70 is not formed in a shape that surrounds the entire circumference of the breathing hole 27. Instead, the drainage rib 70 is formed in a shape that opens toward the lower side Si of the breathing hole 27. The drainage rib 70 has an elongated portion 71 and the pair of lateral portions 73 and as a whole has a U-shape (a horseshoe shape) that is flattened in the up-down direction. The drainage rib 70 guides drainage from the breathing hole 27 toward the lower side Si.

The elongated portion 71 is positioned on the upper side Ue of the breathing hole 27. The elongated portion 71 is elongated linearly along the horizontal direction Su. An inner wall surface 76 of the elongated portion 71 is continuous with the inner peripheral wall surface 27c of the breathing hole 27 in the front-rear direction. An outer wall surface 77 of the elongated portion 71 is opposed to the recess peripheral wall 85 in the up-down direction.

The lateral portions 73 are respectively provided on the two opposite sides of the breathing hole 27 in the horizontal direction Su. The lateral portions 73 extend toward the lower side Si from two opposite ends of the elongated portion 71. The gap surface 83 is interposed between the inner wall surface 76 of the lateral portion 73 and the breathing hole 27, so that the inner wall surface 76 of the lateral portion 73 is positioned apart from the breathing hole 27. The outer wall surface 77 of the lateral portion 73 is opposed to the recess peripheral wall 85 in the horizontal direction Su.

According to the above configuration, a portion of the liquid, which flows from the upper side Ue toward the breathing hole 27, flows along the reference surface portion 21c toward the lower side Si so as to flow on the rear side Go of the housing recess 80. In addition, a portion of the liquid, which flows into the housing recess 80, is divided in the horizontal direction Su by the drainage rib 70 and is discharged from the recess peripheral wall 85 by flowing through the drainage groove formed between the lateral portions 73 and the recess peripheral wall 85 and then flowing along the inclined surface 82.

Furthermore, even if the surface tension of the liquid causes the liquid to flow around the lateral portion 73 and be drawn inside the drainage rib 70, the gap surface 83 provided between the lateral portion 73 and the breathing hole 27 allows the liquid to be discharged toward the lower side Si without reaching the breathing hole 27. In addition, even if the liquid temporarily covers the outer opening 27a, the drainage function of the drainage rib 70 allows the liquid to be discharged along the inner wall surface 76 in the gravity direction (toward the lower side Si) without accumulating in the breathing hole 27.

### Summary of First Embodiment

According to the first embodiment described above, the drainage rib 70, which projects to partially surround the breathing hole 27, guides the drainage from the breathing hole 27 due to the shape of the drainage rib 70 that opens toward the lower side Si of the breathing hole 27. This configuration makes it difficult for the liquid to accumulate in the breathing hole 27. As a result, it is possible to avoid a situation where the ventilation through the breathing hole 27 is obstructed by the liquid, thereby causing deformation of the sensor housing 20 and deterioration of the performance of the sensor circuit board 40.

In addition, the drainage rib 70 of the first embodiment has: the elongated portion 71, which is located on the upper side Ue of the breathing hole 27; and the pair of lateral portions 73, which extend toward the lower side Si from the two opposite ends, respectively, of the elongated portion 71. According to the shape of the drainage rib 70 described above, each of the lateral portions 73 is formed at the position spaced away from the breathing hole 27. Therefore, even if a portion of the liquid flows so as to flow around the lateral portion 73, it becomes difficult for the liquid to reach the outer opening 27a of the breathing hole 27. As a result, the drainage rib 70 enables the draining of the liquid flowing from the upper side Ue in such a manner as to bypass the breathing hole 27.

Furthermore, the sensor housing 20 of the first embodiment has the housing recess 80, which is formed by recessing the rear-side back surface 21a. The outer opening 27a of the breathing hole 27 and the drainage rib 70 are formed on the recess bottom wall 81. Due to the formation of the housing recess 80, the liquid, which flows along the rear-side back surface 21a toward the lower side Si, is less likely to reach the drainage rib 70 and the outer opening 27a located on the lower side Si of the drainage rib 70. In addition, even when the drainage rib 70, which projects toward the rear side Go, is provided, an increase in an overall size of the radar device 100, in other words, the thickness of the sensor housing 20, is minimal. Consequently, any adverse effect on the mountability caused by the addition of the drainage rib 70 is less likely to occur.

Furthermore, the drainage rib 70 of the first embodiment projects from the housing recess 80 beyond the reference surface portion 21c, which is the portion of the rear-side back surface 21a excluding the area where the housing recess 80 is formed. Thus, even when the drainage rib 70 is configured to project from the recess bottom wall 81, the drainage rib 70 can repel the liquid arriving from the upper side Ue along the reference surface portion 21c toward the rear side Go, thereby limiting the liquid from reaching the breathing hole 27.

In addition, in the first embodiment, the drainage rib 70, which has the elongated portion 71 and the pair of lateral portions 73, is formed on the recess bottom wall 81. In this configuration, a spacing between the recess peripheral wall 85 and each lateral portion 73 (more specifically, the outer wall surface 77 of the lateral portion 73) is relatively narrow compared to other locations around the drainage rib 70 in the housing recess 80. Thus, a portion of the liquid, which enters the housing recess 80, may possibly flow along the lateral portion 73 and reach the inner side of the drainage rib 70. However, with the configuration described above, in which the elongated portion 71 separates the lateral portions 73 from the breathing hole 27, even the liquid, which has flowed around, is less likely to reach the outer opening 27a of the breathing hole 27. As described above, the drainage rib 70, which has the U-shape, can exhibit a high drainage function even when the drainage rib 70 is formed on the recess bottom wall 81.

Furthermore, in the first embodiment, at least a portion of the recess bottom wall 81 forms the inclined surface 82, which is inclined to progressively reduce the depth of the housing recess 80 toward the lower side Si. Due to the formation of the inclined surface 82, the liquid, which has flowed into the recess bottom wall 81, is discharged toward the lower side Si of the recess bottom wall 81 without accumulating in the recess bottom wall 81. Therefore, in combination with the drainage function of the drainage rib 70, a situation, in which the liquid accumulates in the breathing hole 27, can be more reliably avoided.

In the embodiment described above, the sensor housing 20 serves as an antenna housing, and the rear-side back surface 21a serves as an outer surface. Also, the sensor circuit board 40 serves as an antenna device, and the recess bottom wall 81 serves as a bottom wall. In addition, the housing outside space OS serves as an outside space.

### Second Embodiment

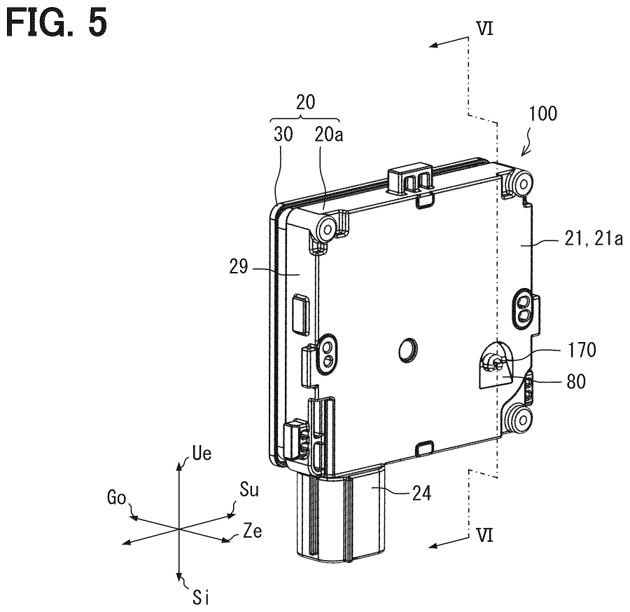

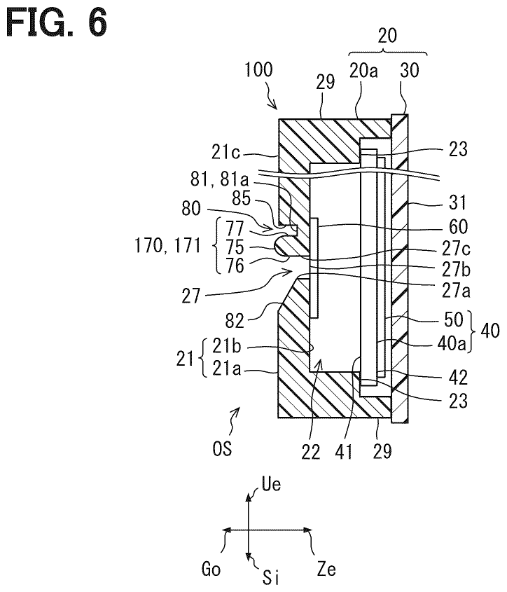

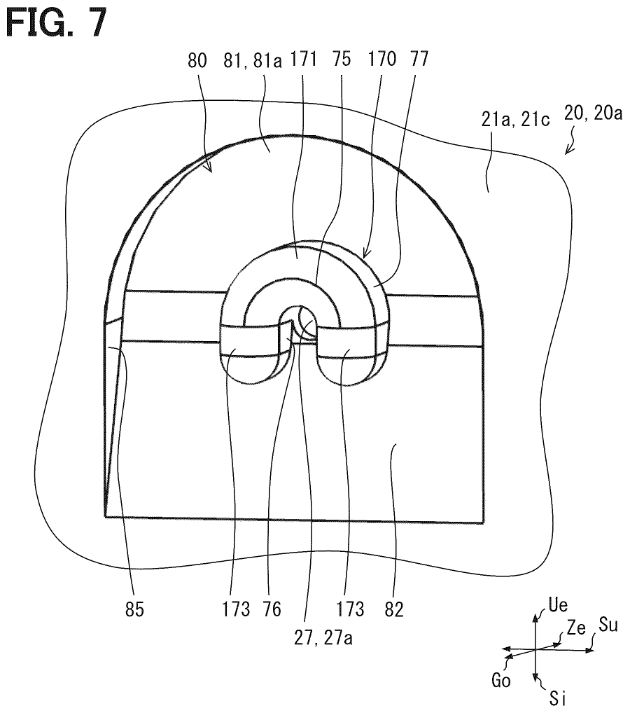

The second embodiment shown in FIGS. 5 to 7 is a modification of the first embodiment. In the radar device 100 according to the second embodiment, the shape of the drainage rib 170 is different from that of the first embodiment. The drainage rib 170 has a canopy 171 and a pair of extensions 173 and as a whole has an inverted U-shape that opens toward the lower side Si. Similar to the first embodiment, the drainage rib 170 is formed on the recess bottom wall 81 of the housing recess 80, and the top 75 of the drainage rib 170 projects toward the rear side Go from the reference surface portion 21c (see FIG. 6).

The canopy 171 is located on the upper side Ue of the breathing hole 27. The canopy 171 extends along an outer peripheral edge of the outer opening 27a and is formed in a partially arcuate shape that partially surrounds a side of the breathing hole 27 which faces the upper side Ue. The inner wall surface 76 of the canopy 171 is continuous with the inner peripheral wall surface 27c of the breathing hole 27 over a half circumference of the inner peripheral wall surface 27c in the front-rear direction. The outer wall surface 77 of the canopy 171 is opposed to the recess peripheral wall 85 in the radial direction in a state where a gap is interposed between the outer wall surface 77 of the canopy 171 and the recess peripheral wall 85. A flow passage (a drainage groove), which conducts the liquid, is formed between the canopy 171 and the recess peripheral wall 85.

The extensions 173 are respectively provided on the two opposite sides of the breathing hole 27 in the horizontal direction Su. The extensions 173 extend toward the lower side Si from two opposite ends of the canopy 171. A lower end of each of the extensions 173 is located on the lower side Si of the outer opening 27a. In the horizontal direction Su, a distance between the inner wall surfaces 76 of the extensions 173 in the horizontal direction Su substantially coincides with the diameter of the breathing hole 27. The outer wall surface 77 of the extension 173 is opposed to the recess peripheral wall 85 in the horizontal direction Su in a state where a gap is interposed between the outer wall surface 77 of the extension 173 and the recess peripheral wall 85. Therefore, a flow passage (a drainage groove), which conducts the liquid toward the lower side Si, is formed between each extension 173 and the recess peripheral wall 85.

According to the above configuration, even when the liquid flows into the housing recess 80, the liquid is guided by the drainage rib 170 such that the liquid flows through the drainage groove defined between the extension 173 and the recess peripheral wall 85 and then flows along the inclined surface 82, whereby the liquid is discharged from the recess peripheral wall 85. Thereby, the liquid flows out toward the lower side Si without reaching the breathing hole 27.

In the second embodiment described above as well, the drainage rib 170, which projects to partially surround the breathing hole 27, guides the drainage from the breathing hole 27 due to the shape of the drainage rib 170 which opens toward the lower side Si of the breathing hole 27. As a result, the same advantages as those of the first embodiment are achieved, and a situation, in which the performance of the sensor circuit board 40 deteriorates, can be avoided.

In addition, the drainage rib 170 of the second embodiment has the canopy 171, which has the partially arcuate shape that partially surrounds the side of the breathing hole 27 which faces the upper side Ue. As a result, the drainage rib 170 is able to promote the discharge of the liquid from the breathing hole 27 in the immediate vicinity of the breathing hole 27, and at the same time prevent the liquid from coming into contact with the breathing hole 27. Therefore, even with the drainage rib 170 having the canopy 171, the deterioration in the antenna performance of the sensor circuit board 40 can be reliably avoided.

### Third Embodiment

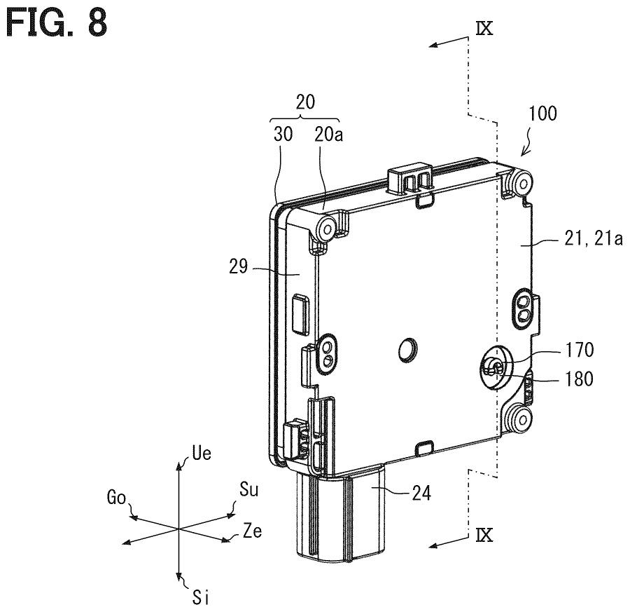

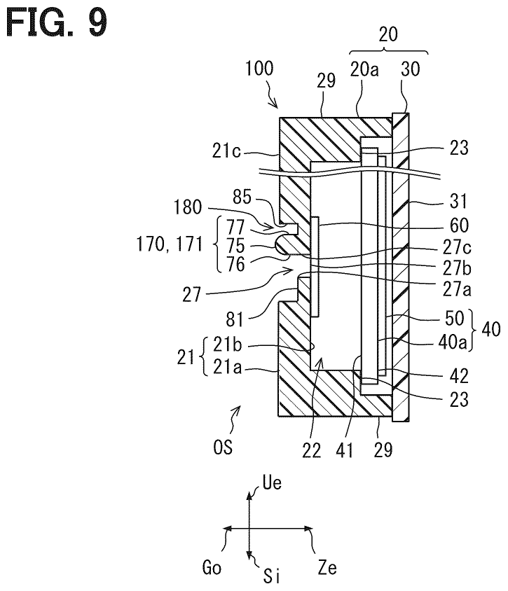

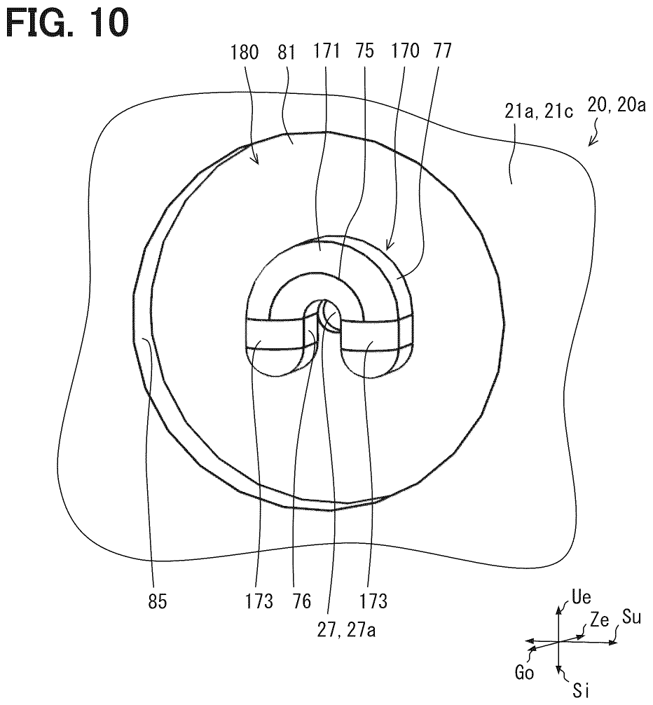

The third embodiment shown in FIGS. 8 to 10 is a modification of the second embodiment. In the radar device 100 according to the third embodiment, the shape of the housing recess 180 is different from that of the first and second embodiments. In the third embodiment, the inclined surface 82 (see FIG. 6) is omitted. The housing recess 180 is formed in a circular shape when viewed from the rear side Go. The housing recess 180 includes: the recess bottom wall 81, which is formed in a circular shape; and the recess peripheral wall 85, which is formed in a cylindrical shape that is flattened. The breathing hole 27 is disposed at the center of the recess bottom wall 81 (see FIG. 9). The drainage rib 170 projects so as to partially surround the outer opening 27a formed at the center of the recess bottom wall 81.

Even in the third embodiment described above, the liquid, which has flowed into the housing recess 180, is guided by the drainage rib 170 and is discharged from the recess peripheral wall 85 without being applied to the breathing hole 27. Thus, the drainage rib 170, by its shape that opens toward the lower side Si of the breathing hole 27, guides the drainage from the breathing hole 27 in the gravity direction. As a result, the same advantages as in the second embodiment are achieved, and the degradation in the antenna performance can be avoided.

### Fourth Embodiment

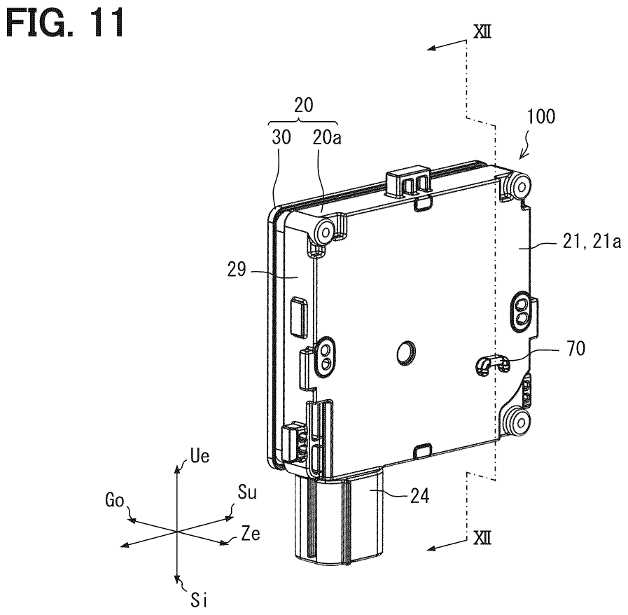

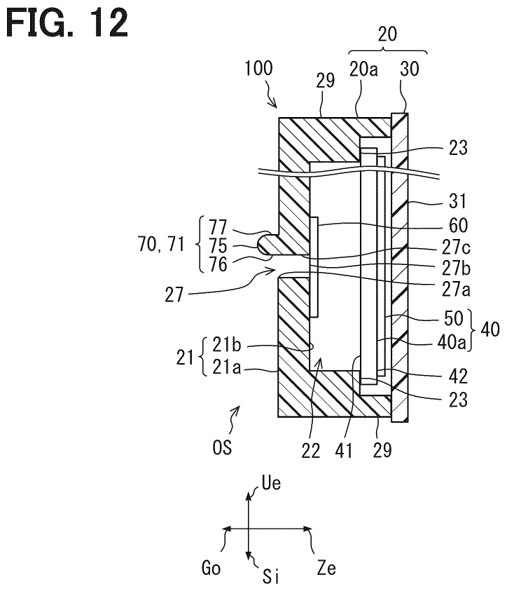

The fourth embodiment shown in FIGS. 11 to 13 is another modification of the first embodiment. In the radar device 100 according to the fourth embodiment, the housing recess 80 is omitted. The drainage rib 70 and the outer opening 27a of the breathing hole 27 are formed on the rear-side back surface 21a at a position that corresponds to the reference surface portion 21c (see FIG. 3). The drainage rib 70 projects toward the rear side Go from the rear-side back surface 21a so as to partially surround the outer opening 27a. The entire drainage rib 70 projects toward the rear side Go beyond the rear-side back surface 21a (see FIG. 12). A gap surface 21d, which corresponds to the gap surface 83 of the first embodiment (see FIG. 4), is formed between each of the lateral portions 73 of the drainage rib 70 and the outer opening 27a of the breathing hole 27.

In the fourth embodiment described above as well, the same advantages as those of the first embodiment are achieved, and the drainage rib 70, which projects to partially surround the breathing hole 27, guides the drainage from the breathing hole 27 due to the shape of the drainage rib 70 which opens toward the lower side Si of the breathing hole 27. Furthermore, even in the case where the liquid flows around the lateral portion 73 and is thereby drawn inside the drainage rib 70, due to the formation of the gap surface 21d, the liquid can be discharged toward the lower side Si without reaching the breathing hole 27. With the above configuration, the situation, in which the antenna performance deteriorates due to the obstruction of the ventilation through the breathing hole 27 by the liquid, can be avoided.

### Fifth Embodiment

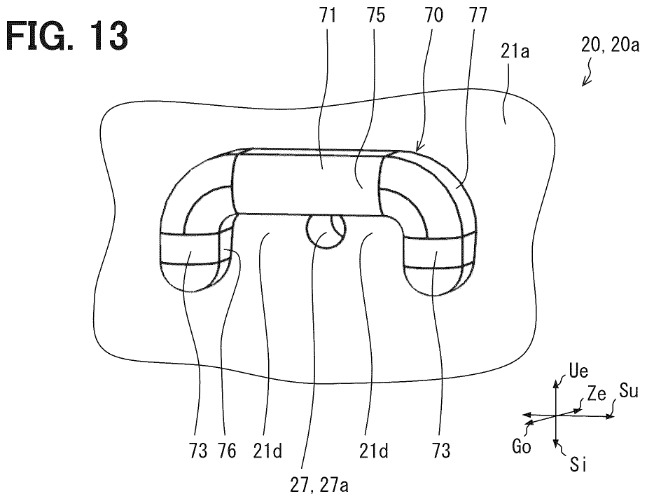

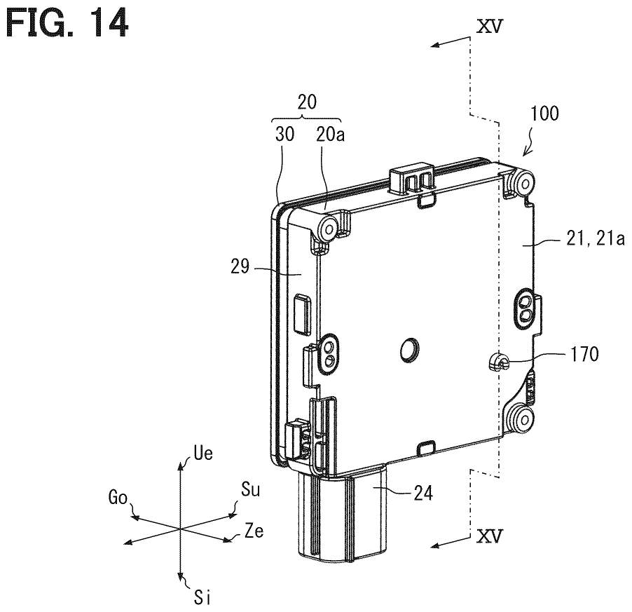

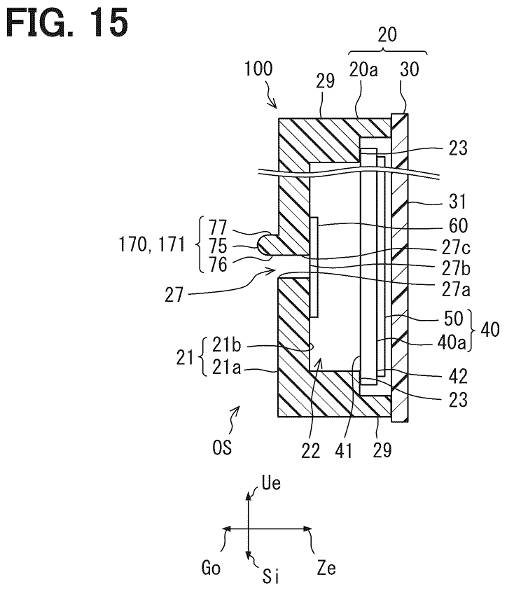

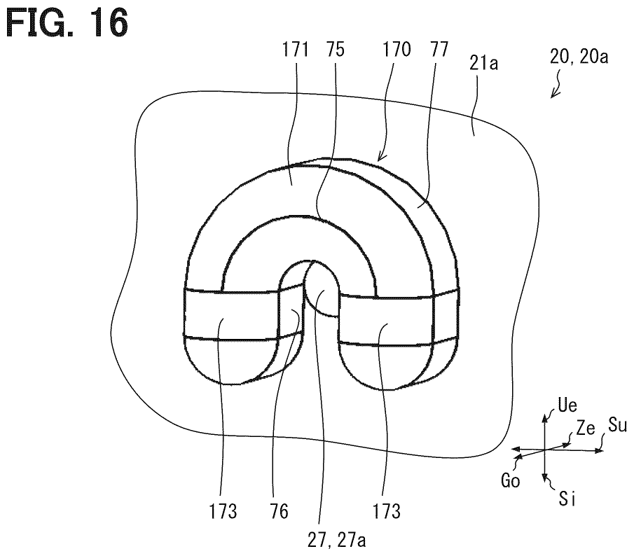

The fifth embodiment shown in FIGS. 14 to 16 is a modification of the fourth embodiment. In the radar device 100 according to the fifth embodiment, in place of the drainage rib 70 (see FIG. 13), the drainage rib 170, which has the same shape as that of the second embodiment, is provided. The drainage rib 170 projects toward the rear side Go from the rear-side back surface 21a so as to partially surround the outer opening 27a. Even in the fifth embodiment, the entire drainage rib 170 projects toward the rear side Go beyond the rear-side back surface 21a (see FIG. 15).

Even in the fifth embodiment described above as well, the drainage rib 170, which projects to partially surround the breathing hole 27, guides the drainage from the breathing hole 27 due to the shape of the drainage rib 170 which opens toward the lower side Si of the breathing hole 27. As a result, the same advantages as in the first to fourth embodiments are achieved, and the degradation in the antenna performance can be avoided.

### Other Embodiments

The embodiments have been explained above. However, the present disclosure is not limited to these embodiments and can be applied to various other embodiments and combinations without departing from the spirit and scope of the present disclosure.

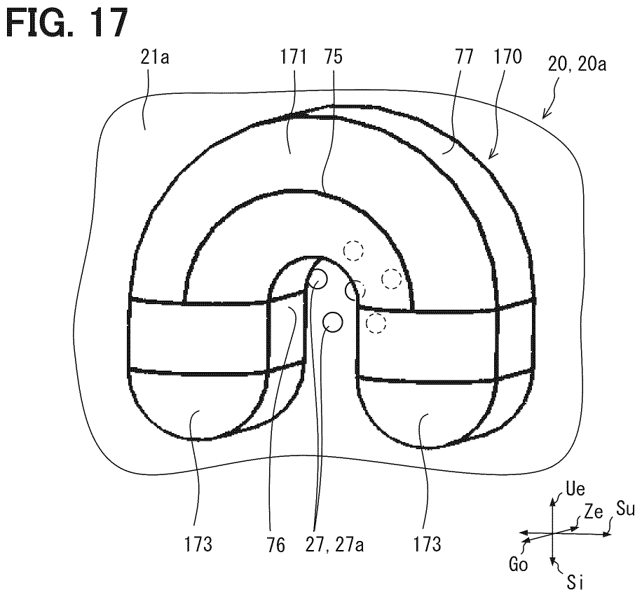

In the sensor housing 20 of a first modification shown in FIG. 17, a plurality (for example, six) of breathing holes 27 are formed to be apart from each other. The drainage rib 170 projects toward the rear side Go from the rear-side back surface 21a so as to partially surround all of the breathing holes 27. The drainage rib 170 has the shape, which opens toward the lower side Si of the breathing holes 27. The drainage rib 170 can limit the accumulation of the liquid at each of the breathing holes 27. Furthermore, the plurality of breathing holes 27 may be provided in the other embodiments described above. As a result, even in the first modification, the same advantages as those of the embodiments described above are achieved, and the situation, in which the antenna performance deteriorates, can be avoided.

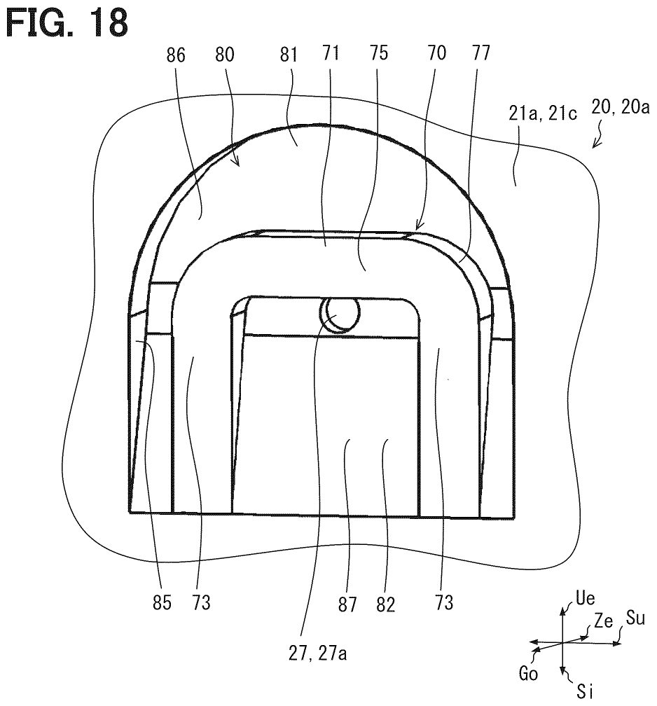

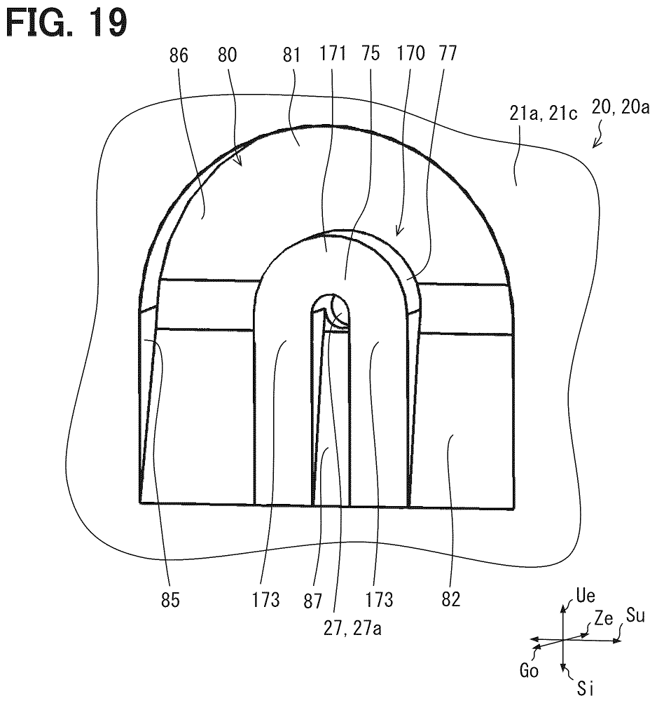

A second modification shown in FIG. 18 is a modification of the first embodiment. In the second modification, the sensor housing 20 has the housing recess 80 that includes: an outer drainage groove 86, which is located apart from the breathing hole 27; and a lower drainage groove 87, which is continuous with the breathing hole 27. A portion of the housing bottom wall 21, which partitions between the outer drainage groove 86 and the lower drainage groove 87, forms the drainage rib 70. Further, a third modification shown in FIG. 19 is a modification of the second embodiment. In the third modification as well, the outer drainage groove 86 and the lower drainage groove 87 form the housing recess 80 in the sensor housing 20. A portion of the housing bottom wall 21, which partitions between the outer drainage groove 86 and the lower drainage groove 87, forms the drainage rib 170. As in the second and third modifications described above, by forming the plurality of drainage grooves on the rear-side back surface 21a, the drainage ribs 70, 170 can be easily formed. In the second and third modifications, the top 75 of the drainage rib 70, which forms a flat surface, is flush with the reference surface portion 21c.

The shape of the drainage rib can be modified as appropriate. The drainage rib may have a linear shape that extends linearly along the horizontal direction Su, or the drainage rib may have an inverted V-shape. In addition, the drainage rib may be formed in a cylindrical tubular shape that is flattened and partially surrounds the breathing hole 27 as a whole, and this drainage rib may have a cutout on the lower side Si of the breathing hole 27. Furthermore, the height of the drainage rib, which projects from the recess bottom wall 81, may be smaller than the depth of the housing recess 80.

The location of the breathing hole 27 and the location of the drainage rib 70 may be appropriately changed within the rear-side back surface 21a in accordance with the internal structure of the radar device 100. In addition, a plurality of sets of breathing holes 27 and drainage ribs 70 may be provided on the rear-side back surface 21a. Furthermore, the breathing hole 27 and the drainage rib 70 may be formed on one of the housing peripheral walls 29.

The vehicle, which has the radar device 100, is not limited to ordinary private passenger cars and may be a rental car, a vehicle for manned taxis, a vehicle for ride-sharing, a cargo vehicle, or a bus, among others. Furthermore, the radar device 100 can also be installed on vehicles dedicated to unmanned (driverless) operation used for mobility services. In addition, the number and installation positions of the radar devices 100 may be appropriately optimized according to the form of the vehicle, the intended use of the vehicle, and factors such as the traffic environment and regulations of the country or region in which the vehicle is used.

Furthermore, the mobile body equipped with the radar device 100 is not limited to vehicles. For example, the radar device 100 according to the present disclosure can also be installed on mobile bodies such as unmanned transport vehicles operated in warehouses, heavy machinery used at work sites, railway vehicles, trams, and electric vertical take-off and landing aircraft (eVTOL), among others.

What is claimed is:

1. A radar device configured to be used in a mobile body, the radar device comprising:
an antenna device that is configured to emit a radio wave so as to detect an object around the mobile body; and
an antenna housing that defines a receiving chamber, which receives the antenna device, wherein the antenna housing forms a breathing hole that is configured to reduce a pressure difference between the receiving chamber and an outside space outside the antenna housing, wherein:
a drainage rib is formed on an outer surface of the antenna housing so as to project from the outer surface of the antenna housing and partially surround the breathing hole, wherein the drainage rib has a shape that opens toward a lower side of the breathing hole so as to guide drainage from the breathing hole;
the antenna housing has a housing recess that is recessed on the outer surface;
an outer opening of the breathing hole and the drainage rib are formed on a bottom wall of the housing recess; and
a spacing between a recess peripheral wall of the housing recess and an outer wall surface of the drainage rib is narrower in a horizontal direction of the breathing hole than on an upper side of the breathing hole.

2. The radar device according to claim 1, wherein the drainage rib projects from the housing recess relative to a reference surface portion of the outer surface which is other than a portion of the outer surface where the housing recess is formed.

3. The radar device according to claim 1, wherein the bottom wall has the drainage rib that includes:
an elongated portion that is positioned on the upper side of the breathing hole; and
a pair of lateral portions that respectively extend from two opposite ends of the elongated portion toward the lower side.

4. The radar device according to claim 1, wherein at least a portion of the bottom wall forms an inclined surface that is inclined to progressively reduce a depth of the housing recess as the housing recess approaches the lower side.

5. The radar device according to claim 1, wherein:
the bottom wall of the housing recess has the drainage rib that includes:
an elongated portion that is positioned on the upper side of the breathing hole; and
a pair of lateral portions that respectively extend from two opposite ends of the elongated portion toward the lower side; and
a range of the bottom wall, which is located on the lower side of the outer opening, forms an inclined surface that is inclined to progressively reduce a depth of the housing recess as the housing recess approaches the lower side.

6. The radar device according to claim 1, wherein:
the breathing hole is one of a plurality of breathing holes formed on the antenna housing; and
the drainage rib is formed so as to project and partially surround the plurality of breathing holes, and the drainage rib is formed to have a shape that opens toward the lower side of the plurality of breathing holes.
